(19) United States
(12) Patent Application Publication
(10) Pub. No.: US 2017/0109867 A1
(43) Pub. Date: Apr. 20, 2017

(54) CAMERA ARRAY FOR PERFORMING NON-LOCAL MEANS IMAGE PROCESSING OVER MULTIPLE SEQUENTIAL IMAGES

(71) Applicant: Motorola Mobility LLC, Chicago, IL (US)

(72) Inventors: Kostyantyn Milshteyn, Cupertino, CA (US); Yuriy Musatenko, Mountain View, CA (US)

(21) Appl. No.: 15/076,518

(22) Filed: Mar. 21, 2016

Related U.S. Application Data
(60) Provisional application No. 62/242,350, filed on Oct. 16, 2015.

(51) Int. Cl. G06T 5/00; G06T 5/50

(52) U.S. Cl. CPC G06T 5/002; G06T 5/50

(57) ABSTRACT

Gathering a plurality of sequential image sets from a scene. The sets include a main sequential image set and one or more additional sequential image sets. The main sequential image set includes a main central image that is near a temporal midpoint of the set, and one or more remaining main images. The additional sequential image sets each include a plurality of additional images comprising an additional central image and one or more additional remaining images. The one or more remaining main images and the plurality of additional images are used to perform filtering of the main central image to provide a filtered main central image having an enhanced signal-to-noise ratio.

### FIELD OF THE DISCLOSURE

The present disclosure relates to image processing and, more particularly, to methods, apparatuses, and systems for providing non-local means image processing of multiple sequential images gathered by a camera array.

### BACKGROUND OF THE DISCLOSURE

Various techniques have been developed for performing filtering and denoising of a single image. One such technique is bilateral filtering. A non-linear, edge-preserving and noise-reducing smoothing filter is applied to the image. The intensity value at each pixel in this single image is replaced by a weighted average of intensity values from nearby pixels. The weights depend not only on the Euclidean distances between pairs of pixels, but also on radiometric differences such as color intensity and depth distance. The weight may be based on a Gaussian distribution. Bilateral filtering preserves sharp edges in the image by systematically looping through each pixel in the image and adjusting the weights of one or more adjacent pixels accordingly.

Another image filtering and denoising technique is non-local means. Unlike local means filters which take the mean value of a group of pixels surrounding a target pixel to smooth the single image, non-local means filtering takes a mean value of all pixels in a single image, weighted by how similar each pixel is to a target pixel. This approach provides a filtered image having greater post-filtering clarity and less loss of detail relative to an image that has been processed using a local means algorithm.

### BRIEF SUMMARY OF THE INVENTION

In at least some embodiments, the present invention relates to a method that includes gathering a plurality of sequential image sets from a scene. The plurality of sequential image sets includes at least a main sequential image set and one or more additional sequential image sets. The main sequential image set includes a plurality of main images comprising a main central image that is at or proximate to a temporal midpoint of the set, and one or more remaining main images. The one or more additional sequential image sets each include a plurality of additional images comprising an additional central image that is at or proximate to a temporal midpoint of the set, and one or more additional remaining images. A first patch is defined as including a first plurality of contiguous pixels in the main central image that surrounds or adjoins a first target pixel of the main central image. A plurality of second patches is defined as including a set of positions corresponding to the first patch within the one or more remaining main images and the plurality of additional images, wherein a single frame of reference is applied to each of the plurality of main images and each of the plurality of additional images. The single frame of reference includes an x-axis and a y-axis, such that a set of x and y coordinates specifying the first target pixel within the main central image also specifies a substantially identical position within each of the remaining main images and each of the plurality of additional images. A set of patch similarity weights is determined by comparing the first patch to each of the plurality of second patches. The set of patch similarity weights is applied to the first target pixel to provide a filtered pixel value for the first target pixel. The foregoing procedure is repeated for at least one additional target pixel of the main central image until a set of filtered pixel values are provided for substantially all pixels of the main central image. The set of filtered pixel values for the first target pixel and the additional target pixels may be used to provide a filtered main central image having an enhanced signal-to-noise ratio.

Additionally, in at least some embodiments, the present invention relates to an apparatus that includes a camera array comprising a main camera and one or more additional cameras, wherein the main camera is configured for gathering a main sequential image set from a scene, and the one or more additional cameras are configured for gathering one or more additional sequential image sets from the scene. The main sequential image set includes a plurality of main images comprising a main central image that is at or proximate to a temporal midpoint of the set, and one or more remaining main images. The one or more additional sequential image sets each include a plurality of additional images comprising an additional central image that is at or proximate to a temporal midpoint of the set, and one or more additional remaining images. The apparatus further includes a processing mechanism operatively coupled to the camera array. The processing mechanism is configured for defining a first patch as including a first plurality of contiguous pixels in the main central image that surrounds or adjoins a first target pixel of the main central image. A plurality of second patches is defined as including a set of positions corresponding to the first patch within the one or more remaining main images and the plurality of additional images, wherein a single frame of reference is applied to each of the plurality of main images and each of the plurality of additional images. The single frame of reference includes an x-axis and a y-axis, such that a set of x and y coordinates specifying the first target pixel within the main central image also specifies a substantially identical position within each of the remaining main images and each of the plurality of additional images. A set of patch similarity weights is determined by comparing the first patch to each of the plurality of second patches. The set of patch similarity weights is applied to the first target pixel to provide a filtered pixel value for the first target pixel. The foregoing procedure is repeated for at least one additional target pixel of the main central image until a set of filtered pixel values are provided for substantially all pixels of the main central image. The set of filtered pixel values for the first target pixel and the additional target pixels may be used to provide a filtered main central image having an enhanced signal-to-noise ratio.

Moreover, in at least some embodiments, the present invention relates to a non-transitory computer readable memory encoded with a computer program comprising computer readable instructions recorded thereon for execution of a method that includes gathering a plurality of sequential image sets from a scene. The plurality of sequential image sets includes at least a main sequential image set and one or more additional sequential image sets. The main sequential image set includes a plurality of main images comprising a main central image that is at or proximate to a temporal midpoint of the set, and one or more remaining main images. The one or more additional sequential image sets each include a plurality of additional images comprising an additional central image that is at or proximate to a temporal midpoint of the set, and one or more additional remaining images. A first patch is defined as including a first plurality of contiguous pixels in the main central image that surrounds or adjoins a first target pixel of the main central image. A plurality of second patches is defined as including a set of positions corresponding to the first patch within the one or more remaining main images and the plurality of additional images, wherein a single frame of reference is applied to each of the plurality of main images and each of the plurality of additional images. The single frame of reference includes an x-axis and a y-axis, such that a set of x and y coordinates specifying the first target pixel within the main central image also specifies a substantially identical position within each of the remaining main images and each of the plurality of additional images. A set of patch similarity weights is determined by comparing the first patch to each of the plurality of second patches. The set of patch similarity weights is applied to the first target pixel to provide a filtered pixel value for the first target pixel. The foregoing procedure is repeated for at least one additional target pixel of the main central image until a set of filtered pixel values are provided for substantially all pixels of the main central image. The set of filtered pixel values for the first target pixel and the additional target pixels may be used to provide a filtered main central image having an enhanced signal-to-noise ratio.

### BRIEF DESCRIPTION OF THE DRAWINGS

FIG. 1 is a flowchart showing an illustrative operational sequence for performing non-local means image processing of multiple sequential image sets gathered by a camera array in accordance with a set of exemplary embodiments.

FIG. 2 is a diagrammatic representation showing an exemplary main sequential image set and an exemplary additional sequential image set.

FIG. 3 is a hardware block diagram showing an illustrative camera array for performing image gathering and non-local means image processing of multiple sequential image sets in accordance with a set of exemplary embodiments.

FIG. 4 is a hardware block diagram showing an illustrative mobile device for performing non-local means image processing of multiple sequential image sets gathered by a camera array in accordance with a set of exemplary embodiments.

### DETAILED DESCRIPTION

If a scene is photographed continuously or repeatedly by a camera array to gather a plurality of images, then a simple windowed averaging of the gathered images over time can theoretically achieve a higher signal-to-noise ratio (SNR) than would be possible for any single gathered image. However, practical application of this approach is limited by at least two factors. First, many scenes are not perfectly still. One or more objects or subjects may be engaged in motion. Second, even if all of the objects and subjects in a given scene were to remain perfectly still, the camera array itself may be in motion. In situations where a scene includes one or more moving objects, or where the camera array is in motion, simple averaging does not perform well and may provide blurry images.

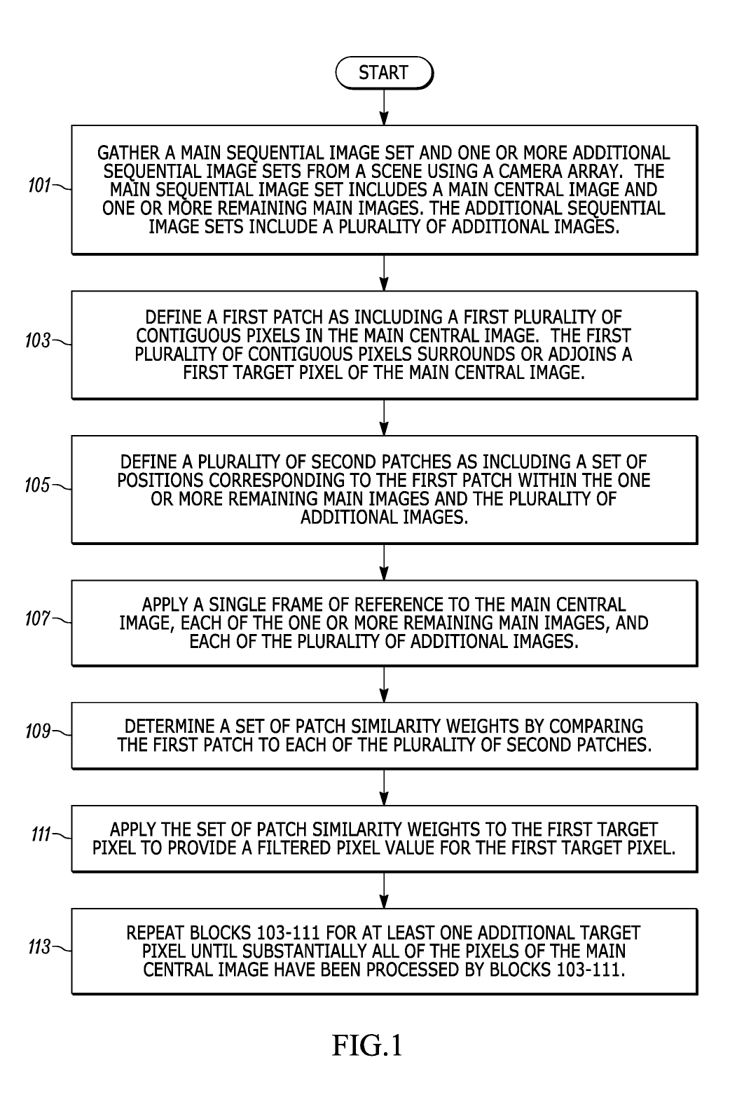

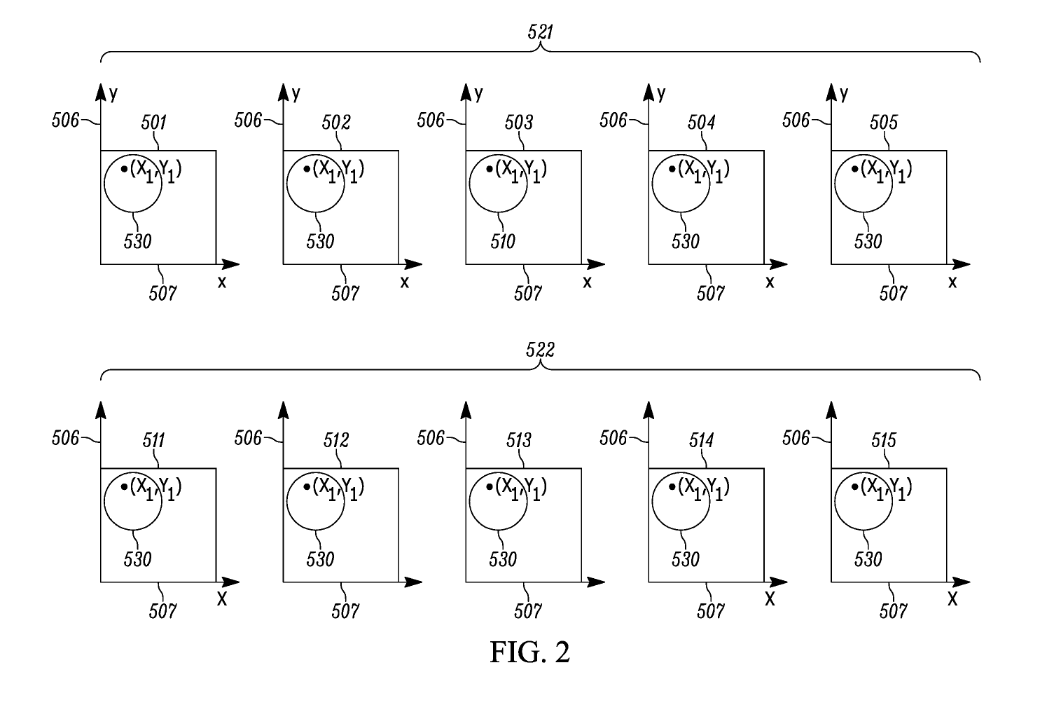

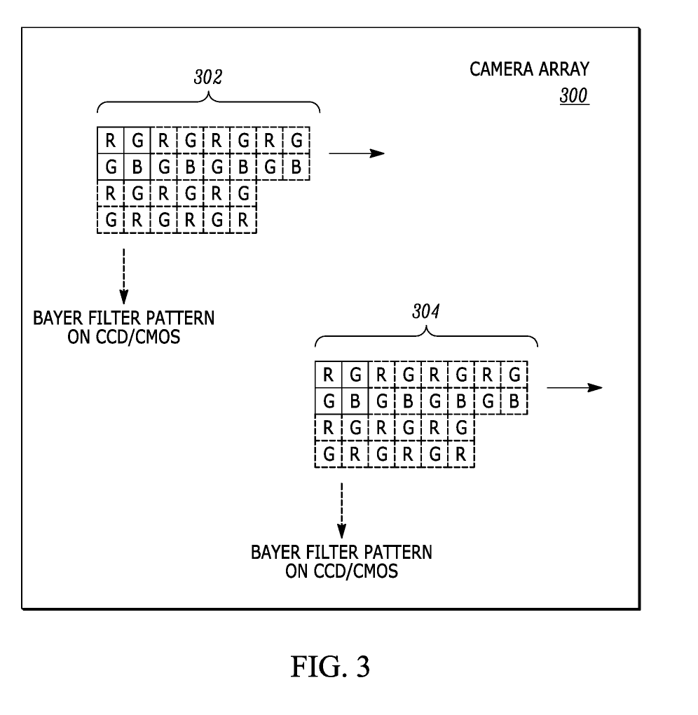

FIG. 1 is a flowchart showing an illustrative operational sequence for performing non-local means image processing of multiple sequential image sets gathered by a camera array in accordance with a set of exemplary embodiments. For explanatory purposes, the flowchart of FIG. 1 will be considered in connection with the diagrammatic representation of FIG. 2 and the hardware block diagram of FIG. 3.

The operational sequence of FIG. 1 commences at block 101 where a main sequential image set 521 (FIG. 2) and one or more additional sequential image sets are gathered from a scene by a camera array 300 (FIG. 3). The one or more additional sequential image sets may include a second sequential image set 522 (FIG. 2). The camera array 300 (FIG. 3) includes at least a first camera 302 and a second camera 304. Illustratively, the main sequential image set 521 (FIG. 2) may be gathered by the first camera 302 (FIG. 3), and the second sequential image set 522 (FIG. 2) may be gathered by the second camera 304 (FIG. 3). The main sequential image set 521 (FIG. 2) includes a main central image 503 that is at or proximate to a temporal midpoint of the set, and one or more remaining main images 501, 502, 504, and 505. The second sequential image set 522 includes an additional central image 513 that is at or proximate to a temporal midpoint of the second sequential image set 522, and one or more additional remaining images 511, 512, 514, and 515.

Next, at block 103 (FIG. 1), a first patch 510 (FIG. 2) is defined as including a first plurality of contiguous pixels in the main central image 503. The first plurality of contiguous pixels surrounds or adjoins a first target pixel (x₁, y₁) of the main central image 503. Then, at block 105 (FIG. 1A), A plurality of second patches 530 (FIG. 2) is defined as including a set of positions corresponding to the first patch within the one or more remaining main images 501, 502, 504, and 505, and the plurality of additional images 511, 512, 513, 514, and 515. The operational sequence of FIG. 1 progresses to block 107 where a single frame of reference is applied to each of the plurality of main images 501, 502, 503, 504, and 505 (FIG. 2), and each of the plurality of additional images 511, 512, 513, 514, and 515. The single frame of reference includes an x-axis 507 and a y-axis 506, such that a set of x and y coordinates specifying the first target pixel (x₁, y₁) within the main central image 503 also specifies a substantially identical position within each of the remaining main images 501, 502, 504, and 505, and also within each of the plurality of additional images 511, 512, 513, 514, and 515.

The operational sequence of FIG. 1 advances to block 109 where a set of patch similarity weights is determined by comparing the first patch 510 (FIG. 2) to each of the plurality of second patches 530. Illustratively, these patch similarity weights may be determined with reference to at least one characteristic or attribute of the first patch 510 and the plurality of second patches 530, such as grey scale values, luminance values, chrominance values, red (R) values, green (G) values, blue (B) values, or any of various combinations thereof. Then, at block 111 (FIG. 1), the set of patch similarity weights is applied to the first target pixel (x₁, y₁) (FIG. 2) to provide a filtered pixel value for the first target pixel (x₁, y₁) (of the main central image 503).

Next, at block 113 (FIG. 1), the steps of blocks 103-11 are repeated for at least one additional target pixel of the main central image 503 (FIG. 2). These steps may be repeated until a set of filtered pixel values are provided for substantially all of the pixels of the main central image 503. Alternatively or additionally, the steps of blocks 103-111 (FIG. 1) may be performed in parallel for a plurality of target pixels. The set of filtered pixel values for the first target pixel (x₁, y₁) and the at least one additional target pixel may be used to provide a filtered main central image 503 having an enhanced signal-to-noise ratio.

Although the procedure of FIG. 1 illustrates the main sequential image set 521 (FIG. 2) comprising a plurality of main images 501, 502, 503, 504, and 505, a single-image case will now be considered for explanatory purposes. For the first target pixel (x₁, y₁) to be filtered, the weight of an accounting pixel (x_{q}, y_{q}) is given by:

w_{pq}=|Vₚ−V_{q}|

where subscript p denotes first target pixel (x₁, y₁) and subscript q denotes accounting pixel (x_{q}, y_{q}). Accounting pixel (x_{q}, y_{q}) could, but need not, be the same pixel as second target pixel (x₂, y₂). Vₚ is a vector representing a group of contiguous pixels comprising first patch 510 and centered at first target pixel (x₁, y₁). V_{q} is a vector representing a group of contiguous pixels comprising a further patch and centered at second target pixel (x₂, y₂). This further patch could, but need not, be identical to any of the plurality of second patches 530. A norm of the vector difference Vₚ−V_{q} is indicative of a distance measure between the patches for first target pixel (x₁, y₁) and accounting pixel (x_{q}, y_{q}), which is typically an L1 or L2 norm of the vector difference. Typically, some function f( ) of the norm is used as the weight. A non-local means (NLM) algorithm may illustratively be used to supply this function f( ).

Thus, the filtered pixel output value, denoted as Iₚ, is given by:

$${I}_{p} = {\sum }_{q} {I}_{q} \cdot {w}_{pq}$$

Each of a plurality of accounting pixels (x_{q}, y_{q}) may be selected from a contiguous patch area that is proximate to first target pixel (x₁, y₁). This patch area may be defined in terms of a window having a window size, where the window is centered at the first target pixel (x₁, y₁). At one extreme, the window size can be specified so as to cover an entire image, but such an implementation may render the filter complexity too great to implement. Vectors Vₚ and V_{q} typically represent patches of size from approximately 3 to 11, but these patches can be larger or smaller. For purposes of illustration, when the size of the patch is set to a single pixel, the pixel filtering result of the non-local means approach is close to the result that would be achieved using a bilateral filter.

Returning to the case of sequential images, the set of pixels used to determine the weighted average is extended from pixels of a window around first target pixel (x₁, y₁) in the main central image 503 (FIG. 2) of the main sequential image set 521 to account also for pixels that are near or proximate to the same coordinates as first target pixel (x₁, y₁) in one or more remaining main images 501, 502, 504, and 505 of the set of sequential images. In many but not all situations, each main image 501, 502, 503, 504, and 505 in the main sequential image set 521 will be very similar to all other images in the set. Applying identical or substantially similar patches or masks to the one or more remaining main images 501, 502, 504, and 505 has a positive impact in terms of producing better and more precise filtered values for first target pixel (x₁, y₁). This procedure can be applied to multiple target pixels including, for example, the second target pixel (x₂, y₂). Each of the target pixels may be processed sequentially, or in parallel with one or more other target pixels, or a combination of parallel and sequential processing may be employed. Any number of one or more remaining main images 501, 502, 504, and 505, and any number of additional sequential image sets 522 may be used to filter main central image 503. For example, having a series of sequential images that includes N total images (including central image 503 and (N−1) remaining images 501, 502, 504, and 505) will improve the signal-to-noise ratio over the single-image case by the square root of N.

As a practical matter, it may be difficult or impossible for a camera array to remain perfectly still during the entire time interval that the set of sequential images is being gathered. This factor may result in individual images of the set of sequential images being offset one relative to each other, thereby decreasing the overall quality of filtering. One technique for addressing this issue is to determine a position alignment offset for each image of the set of sequential images prior to determining where a window center corresponding to the coordinates of pixel p in the central image shall be placed on other non-central images of the set of sequential images. Although any of various techniques could be used to determine the offset, illustratively the offset is determined using feature points detection to identify one or more pixels corresponding to a given feature in each of a plurality of images of the set of sequential images. By identifying the location of the identified feature in each of the plurality of images, an appropriate offset is calculated for each of the plurality of images.

The aforementioned operational sequence of FIG. 1 merely provides a set of illustrative examples that are intended to be encompassed by the present disclosure. The present disclosure is intended to encompass numerous other manners of operation in addition to those specifically described previously. Numerous other examples of operation in accordance with the processes of FIG. 1, or variations of these processes, can be envisioned and are encompassed herein.

FIG. 3 is a hardware block diagram showing an illustrative camera array 300 for performing image gathering and non-local means image processing of multiple sequential images in accordance with a set of exemplary embodiments. The camera array 300 is an electronic image gathering device that utilizes a plurality of solid-state image sensor arrays. In the illustrative example of FIG. 3, the camera array 300 includes two or more cameras such as the first camera 302 and the second camera 304. The first camera 302 may include a first image sensor array, and the second camera 304 may include a second image sensor array. The first image sensor array could, but need not, be substantially identical to the second image sensor array. However, it is to be understood that the camera array 300 could include more than two cameras. The first and second sensor arrays used, respectively, in the first and second cameras 302, 304 may be provided in the form of charge-coupled devices (CCD) or CMOS light sensors. The first and second sensor arrays each include a plurality of individual sensor elements arranged in a lattice pattern, each sensor element representing a picture element or pixel. The sensor elements convert sampled or sensed light intensities into corresponding electronic video signals that may be transmitted to a display device, such as a video monitor or display screen, that reproduces the images represented by the video signals.

Pursuant to one set of illustrative embodiments, the first and second image sensor arrays each include a predetermined filter pattern of color pixels. For purposes of illustration, the first image sensor array may be implemented using a first Bayer camera array, and the second image sensor array may be implemented using a second Bayer camera array. The first Bayer camera array includes a first CCD having a predetermined color filter pattern, and the second Bayer camera array includes a second CCD having a predetermined color filter pattern substantially identical to that of the first CCD. Each of a plurality of squares on the first and second image sensor arrays represents a corresponding pixel. Bayer camera arrays incorporate a filter mosaic in the form of a color filter array (CFA) in which red, green, and blue color filtering elements are arranged in a predetermined repeating pattern on a square grid of photosensors. Each square has two diagonally opposed green (G) pixel elements, and two diagonally opposed red (R) and blue (B) elements. The pattern includes 50% green filtering elements, 25% red filtering elements, and 25% blue filtering elements, and is referred to as an RGBG, GRGB, or RGGB array. These arrays are used in single-chip CCD sensors that are incorporated into digital cameras, camcorders, scanners, smartphones, and mobile devices to create a color image.

Alternatively or additionally, any of a number of other types of image sensor arrays may be employed in the configuration of FIG. 3 including camera arrays that are configured using a tri-stripe pattern of red, green, and blue filtering elements, clear camera arrays that employ no color filtering, or camera arrays that employ a combination of different color filter patterns.

In at least some sets of embodiments, a sequence of images is gathered using a plurality of Bayer camera arrays including at least a first Bayer camera array and a second Bayer camera array. Illustratively, the first Bayer camera array and the second Bayer camera array operate in close synchronization such that both of the Bayer camera arrays gather a respective image of a sequence of a scene at substantially the same instant in time. Next, a spatial alignment procedure is employed to align a first plurality of images that were gathered at a plurality of different moments in time by the first Bayer camera array, and also to align a second plurality of images that were gathered at the plurality of different moments in time by the second Bayer camera array. The spatial alignment procedure also aligns a third plurality of images that were gathered by either or both of the first Bayer camera array and the second Bayer camera array from different perspectives.

After this spatial alignment procedure is performed, the non-local means procedure of FIG. 1 is performed over multiple images as described previously, taking into account any offsetting that is applied to successively gathered images of the image sequence. The step of gathering a set of sequential images at block 101 (FIG. 1) may further include selecting a central image from the first plurality of images, the second plurality of images, or the third plurality of images that were gathered by the first Bayer array camera or the second Bayer array camera. This selection is performed such that at least one image of the first, second, or third plurality of images was gathered prior to the selected central image, and wherein at least one image of the first, second, or third plurality of images was gathered subsequent to the selected central image. The selected central image is then considered to be the central image for the first, second, and third plurality of images. Incorporating this offset into the procedure of FIG. 1 will produce improved image quality, such that the signal-to-noise ratio will be enhanced in proportion to the square root of (N*M), where N represents a number or quantity of sequential images that have been gathered over a duration of time, and M represents a number or quantity of image sensor arrays (such as first and second image sensor arrays of the first and second cameras 302, 304 (FIG. 3)) that were used to gather these sequential images.

Pursuant to another set of illustrative embodiments, the first image sensor array is implemented using a clear image sensor that does not include color pixels, and the second image sensor array includes a predetermined filter pattern of color pixels. Thus, the first image sensor array produces a greyscale (W) output, and the second image sensor array produces a red-green-blue (RGB) output. In order to process images gathered by the first and second image sensor arrays together, the RGB output of the second image sensor array may be converted to a standard Y′UV color space or a standard L*a*b color space (or also, alternatively, a Luv color space or other color space). The Y′UV model defines a color space in terms of one luma (Y′) and two chrominance (UV) components. When performing denoising, intensity (Y′ or L) are employed together with the greyscale output (W). Y′ is a linear combination of R, G, and B. There are standard conversion formulas for deriving this linear relationship, such as Y′=0.299R+0.587G+0.114B, U=0.492(B−Y′), and V=0.877(R−Y′). However, for matching color with greyscale images this linear combination will have different weight coefficients than for a standard RGB to Y conversion.

When performing main central clear image denoising together with a sequence of clear images of the first sensor and Bayer images of the second sensor, for calculating optimal clear target pixels similarity weights w_{pq} there should be accounting for different noise levels in the clear and Bayer luma images. As clear pixels have a higher signal-to-noise ratio, their patch similarity should be accounted for with a correspondingly larger weight. The optimal multiplier to account for clear pixel weight relative to Bayer luma pixel weight depends on the noise standard deviation of clear and Bayer luma images and can be estimated based thereon. As discussed further herein, the noise standard deviation depends on pixel intensity and therefore the multiplier shall account for that as well.

Joint NLM based denoising of clear channel values W and color (Bayer) luma Y′ as described above can work well if, for matching points, W and Y′ have very similar values. Due to the nature of W and Y′, in most cases initially these values will not be similar or closely matching. Therefore, a special procedure can be applied to make these values match more closely in terms of absolute intensity values. Any of various approaches may be employed to achieve a better match. Pursuant to a first approach, a Luma conversion formula such as Y′=0.299R+0.587G+0.114B can be optimized in the image with custom coefficients using linear regression or any other method to provide better matching. Optimization can be performed on some reselected image areas, like flat areas or special feature points, and then applied to the whole image and used further for joint denoising.

A second approach may be employed to make the absolute intensity values for W and Y′ match more closely. A good measure of similarity can be achieved by creating a W to Y′ relation map for the whole image of Y′ using a disparity map. A relation factor K=W(p)/Y′(p) calculated for every pixel then can be filtered, for example, with a median filter, a bilateral filter, an edge preserving filter, or a generic filter. Then an Image with a relation factor K can be applied to the whole Y′ image and this will produce a very well-matching Y′ image with respect to clear image W. Using this approach, one can obtain clear and color (Bayer) images that can be efficiently filtered together using the foregoing multi-image NLM approach. Other approaches are possible to make clear and Luma derived from color (Bayer) images more similar in terms of absolute intensity values, so that the clear and color images will work well together in the multi-image NLM approach.

One additional approach may be utilized for making the greyscale and color patches more similar, such that the absolute intensity values for W and Y′ match more closely. A mean offset value is calculated between a central patch surrounding (or adjoining) the target pixel of the main clear image and the luma Y′ component of a central patch of the color (Bayer) image. This mean offset value is then added in real time (i.e., on the fly) to all pixels within a window in the color (Bayer) luma image, thus making the patch values more similar to the central patch of the clear image.

Notwithstanding the above discussion, the present disclosure is also intended to encompass additional manners or procedures of calculating intensity offset values between pixels of clear images and color (Bayer) images so as to provide more precise estimations of offsets. For example, it should be recognized that the patch size over which an intensity offset is estimated can be different from the patch size used for NLM's patch similarity weight calculations. Further for example, larger patch sizes can be useful for more noisy images, and particularly can allow for more accurate estimation of intensity offset in such circumstances. Also, intensity offset estimation can be performed through the use of a difference of mean pixel intensity values or through the use of a mean value of pixel intensity differences of patches.

Additionally for example, another manner of estimating intensity offset involves the use of histograms of patches' pixel intensity values. An offset can be determined by searching for a offset value that makes the color (Bayer) patch histogram most similar to a corresponding histogram of a clear patch, where that value can then be (or be used to further calculate) the desired intensity offset. Similarity of histograms at a certain offset can be calculated in any of a number of manners, for example, as the value of a sum of absolute or squared differences or some other metric. Before applying these metrics, the histograms can be smoothed or filtered in any of a variety of manners to make the comparison more suitable for the circumstance. A similarity metric can account for positions of histogram maximum and minimum values or other histogram peculiarities. Given that different intensities can have different offsets, histogram similarity matching can be done not merely by optimizing just a single parameter (such as offset), but also by using additional parameters as well. Such additional parameters can be coefficients of linear or higher order polynomial fit of offset (intensity) dependence. Further, as fit coefficients are estimated for a central clear image patch and corresponding Bayer luma patch, those coefficients can be used for more precise Bayer pixel luma offset estimation of neighboring Bayer luma pixels (against correspondent clear pixels) for further Bayer patch similarity weight estimation for use in enhanced joint NLM denoising. Thus, higher quality noise reduction for a main central clear image can be achieved.

In a set of illustrative approaches described previously, sets of weights of accounting for clear pixels and color (Bayer) pixels are fixed and are typically determined based on a standard deviation of noise in the clear and color (Bayer) images. This task is typically performed based upon an assumption that the noise possesses the statistics of shot noise across all light levels (or pixel intensity levels). However, in low-light situations, read noise prevails in some of the darker regions of an image. Depending on the exposure time of each image in an image sequence, the balance between read noise and shot noise may be different for each of the images in the sequence. Therefore, an optimal weighting of a set of pixels that are used for weighting or modifying a new central pixel should account for a more complex dependency of the standard deviation of noise across a plurality of different pixel intensity levels. For each of a plurality of different pixel intensity levels, a set of optimal weights may be refined and estimated for optimal noise performance (where the weights can also be considered to be RGB to luma conversion coefficients). This refinement may involve offline profiling of sensor read noise and shot noise characteristics for applying these characteristics in run time. After profiling a known gain and a known exposure time, noise standard deviation at a given intensity or local area average intensity may be estimated, thus enabling a derivation of custom weights for accounting for clear and color (Bayer) luma pixels for a given central pixel or patch.

Any of the first, second, or additional approaches outlined in the foregoing paragraphs may be employed in the context of a first sensor array that includes a predetermined pattern of color pixels, and a second sensor array that includes a clear image sensor. The first sensor array outputs a luma Y′ value having a first absolute intensity level. The second image sensor array outputs a greyscale W value having a second absolute intensity level. The approaches described herein improve a match between the first and second absolute intensity levels, such that the first absolute intensity level is closer to the second absolute intensity level.

In situations where the filtered pixel value at block 111 (FIG. 1) is to be provided in RGB format, a two-step procedure may be performed where a filtered Y′ component is obtained as the filtered pixel output. The weights that were used for calculating the filtered Y′ component can then be directly applied to the U and V components to generate a U and V-filtered pixel output. This approach may provide an enhanced filtered pixel output relative to using separate UV filtering because the Y′ component is expected to contain more information for implementing an adaptive filtering procedure.

Optionally, more than one clear image sensor array, or more than one color image sensor array, or any of various combinations thereof, may be provided. Using a clear image sensor and a color image sensor is similar to the previous example of using two color image sensors. However, clear image sensor arrays may provide pixel outputs having a higher signal-to-noise ratio than color image sensor arrays. The patch similarity weights at block 109 (FIG. 1) may be determined by calculating a set of weighted averages. Thus, a clear patch may be assigned a set of proportionally higher weights than a colored patch in accordance with the signal-to-noise ratio of the clear patch. This approach provides optimal filtering output and maximizes use of clear and Bayer pixel values.

According to a set of illustrative embodiments, the gathered sequential images may be greyscale images. According to another set of illustrative embodiments, the gathered sequential images are color images having red, green, and blue components, and filtering is applied to each of the red, green, and blue components separately.

Pursuant to another set of illustrative embodiments, the procedure of FIG. 1 may be utilized to perform enhanced chroma filtering. A simplified exemplary approach performs separation of a plurality of chroma components for the set of sequential images in a standard YUV or La*b* chroma space. Another illustrative approach provides denoising in the standard YUV or La*b* chroma space. In a more extended form, chroma filtering is performed jointly with luminance (luma) filtering at block 111 (FIG. 1). Thus, for each image in the sets of sequential images, statistics are gathered in the form of a weighted average by determining a respective pixel similarity factor and a corresponding pixel weight for each of the plurality of contiguous second pixels, so that patch similarity is computed by considering luma and chroma information. This procedure provides filtering of both luma and chroma noise within single pass.

The simplified or extended approach to chroma and color image filtering can be applied to the camera array 300 (FIG. 3) in the context of a sequence of shots, so as to provide a set of sequential images with an enhanced signal-to-noise ratio. If clear cameras are present within the camera array 300, then filtering may be performed as a two-step procedure. A first filtering step is performed only with respect to any color camera or cameras in the camera array 300. Next, a second filtering step is performed with respect to any clear camera or cameras in the camera array 300. Optionally, the second filtering step may be implemented using a guided filter approach.

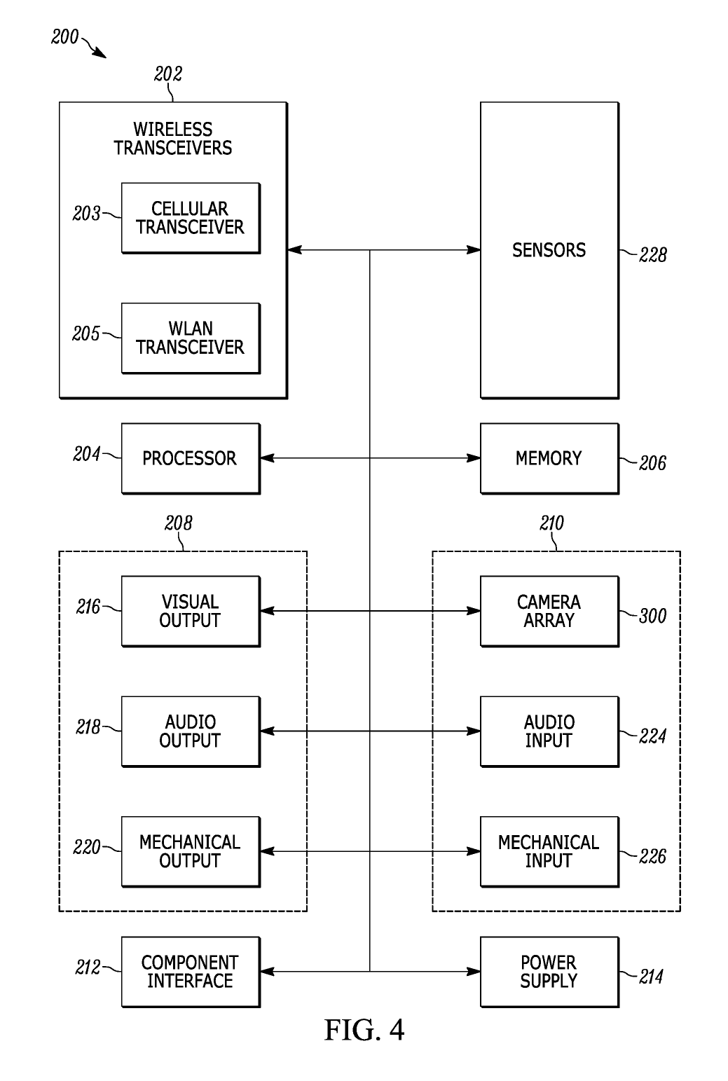

FIG. 4 is a hardware block diagram showing an illustrative mobile device 200 for performing non-local means image processing of multiple sequential images gathered by a camera array in accordance with a set of exemplary embodiments. The mobile device 200 is representative of any communication device that is operated by persons (or users) or possibly by other entities (e.g., other computers) desiring or requiring communication capabilities. In some embodiments, for example, the mobile device 200 may be any of a smartphone, a cellular telephone, a personal digital assistants (PDA), another type of handheld or portable electronic device, a headset, an MP3 player, a battery-powered device, a wearable device, a wristwatch, a radio, a navigation device, a laptop or notebook computer, a netbook, a pager, a PMP (personal media player), a DVR (digital video recorder), a gaming device, a game interface, a camera, an e-reader, an e-book, a tablet device, a navigation device with a video-capable screen, a multimedia docking stations, or another type of electronic mobile device.

As shown in FIG. 4, the illustrative mobile device 200 includes one or more wireless transceivers 202, a processor 204 (e.g., a microprocessor, microcomputer, application-specific integrated circuit, etc.), a memory 206, one or more output devices 208, and one or more input devices 210. In at least some embodiments, a user interface is present that comprises one or more output devices 208, such as a display, and one or more input devices 210, such as a keypad or touch sensor. The mobile device 200 can further include a component interface 212 to provide a direct connection to auxiliary components or accessories for additional or enhanced functionality. The mobile device 200 preferably also includes a power supply 214, such as a battery, for providing power to the other internal components while enabling the mobile device to be portable. Some or all of the components of the mobile device 200 can be coupled to one another, and in communication with one another, by way of one or more internal communication links 232 (e.g., an internal bus).

In the present embodiment of FIG. 4, the wireless transceivers 202 particularly include a cellular transceiver 203 and a wireless local area network (WLAN) transceiver 205. More particularly, the cellular transceiver 203 is configured to conduct cellular communications, such as 3G, 4G, 4G-LTE, etc., vis-à-vis cell towers (not shown), albeit in other embodiments, the cellular transceiver 203 can be configured instead or additionally to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof.

The WLAN transceiver 205 may, but need not, be configured to conduct Wi-Fi communications in accordance with the IEEE 802.11 (a, b, g, or n) standard with access points. In other embodiments, the WLAN transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the WLAN transceiver 205 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology. Thus, although in the present embodiment the mobile device 108 has two of the wireless transceivers 203 and 205, the present disclosure is intended to encompass numerous embodiments in which any arbitrary number of (e.g., more than two) wireless transceivers employing any arbitrary number of (e.g., two or more) communication technologies are present.

Exemplary operation of the wireless transceivers 202 in conjunction with others of the internal components of the mobile device 200 can take a variety of forms and can include, for example, operation in which, upon reception of wireless signals, the internal components detect communication signals and the transceiver 202 (FIG. 2) demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals by way of wireless and (possibly wired as well) communication links to other devices such as the server 106 and one or more of the content provider websites (as well as possibly to other devices such as a cell tower, access point, or another server or any of a variety of remote devices).

Depending upon the embodiment, the mobile device 200 may be equipped with one or more input devices 210, or one or more output devices 208, or any of various combinations of input devices 210 and output devices 208. The input and output devices 208, 210 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 can include, among other things, a video screen.

The input devices 210 include the camera array 300 of FIG. 3. Likewise, by example, the input devices 210 (FIG. 4) may, but need not, include one or more sensors 228, or one or more audio input devices 224 such as a microphone, or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the mobile device 200 (if the device can take on open or closed positions), unlocking the device, moving the device to actuate a motion, moving the device to actuate a location positioning system, and operating the device.

The mobile device 200 may also include one or more of various types of sensors 228. The sensors 228 can include, for example, proximity sensors (a light detecting sensor, an ultrasound transceiver or an infrared transceiver), touch sensors, altitude sensors, a location circuit that can include, for example, a Global Positioning System (GPS) receiver, a triangulation receiver, an accelerometer, a tilt sensor, a gyroscope, or any other information collecting device that can identify a current location or user-device interface (carry mode) of the mobile device 200. Although the sensors 228 are for the purposes of FIG. 4 considered to be distinct from the input devices 210, in other embodiments it is possible that one or more of the input devices can also be considered to constitute one or more of the sensors (and vice-versa). Additionally, even though in the present embodiment the input devices 210 are shown to be distinct from the output devices 208, it should be recognized that in some embodiments one or more devices serve both as input device(s) and output device(s). For example, in embodiments where a touchscreen is employed, the touchscreen can be considered to constitute both a visual output device and a mechanical input device.

The memory 206 of the mobile device 200 can encompass one or more memory devices of any of a variety of forms (e.g., read-only memory, random access memory, static random access memory, dynamic random access memory, etc.), and can be used by the processor 204 to store and retrieve data. In some embodiments, the memory 206 can be integrated with the processor 204 in a single device (e.g., a processing device including memory or processor-in-memory (PIM)), albeit such a single device will still typically have distinct portions/sections that perform the different processing and memory functions and that can be considered separate devices.

The data that is stored by the memory 206 can include, but need not be limited to, operating systems, applications, and informational data, such as a database. Each operating system includes executable code that controls basic functions of the communication device, such as interaction among the various components included among the mobile device 200, communication with external devices via the wireless transceivers 202 and/or the component interface 212, and storage and retrieval of applications and data, to and from the memory 206.

In addition, the memory 206 can include one or more applications for execution by the processor 204. Each application can include executable code that utilizes an operating system to provide more specific functionality for the communication devices, such as file system service and the handling of protected and unprotected data stored in the memory 206. Informational data is non-executable code or information that can be referenced and/or manipulated by an operating system or application for performing functions of the communication device. One such application is a client application which is stored in the memory 206 and configured for performing the methods described herein. For example, one or more applications may be configured to implement the non-local means filter described at block 107 (FIG. 1A) and block 113 (FIG. 1B).

The client application is intended to be representative of any of a variety of client applications that can perform the same or similar functions on any of various types of mobile devices, such as mobile phones, tablets, laptops, etc. The client application is a software-based application that operates on the processor 204 (FIG. 4) and is configured to provide an interface between one or more input devices 210, or one or more output devices 208, or any of various combinations thereof. In addition, the client application governs operation of one or more of the input and output devices 210, 208. Further, the client application may be configured to work in conjunction with a visual interface, such as a display screen, that allows a user of the mobile device 200 to initiate various actions. The client application can take any of numerous forms and, depending on the embodiment, be configured to operate on, and communicate with, various operating systems and devices. It is to be understood that various processes described herein as performed by the mobile device 200 can be performed in accordance with operation of the client application in particular, and/or other application(s), depending on the embodiment.

It should be appreciated that one or more embodiments encompassed by the present disclosure are advantageous in one or more respects. Thus, it is specifically intended that the present disclosure not be limited to the embodiments and illustrations contained herein, but include modified forms of those embodiments including portions of the embodiments and combinations of elements of different embodiments as come within the scope of the following claims.

What is claimed is:

1. A method comprising:
(a) gathering a plurality of sequential image sets from a scene, the plurality of sequential image sets including at least a main sequential image set and one or more additional sequential image sets, wherein the main sequential image set includes a plurality of main images comprising a main central image that is at or proximate to a temporal midpoint of the set, and one or more remaining main images, and wherein the one or more additional sequential image sets each include a respective plurality of additional images comprising an additional central image that is at or proximate to a temporal midpoint of the set, and one or more additional remaining images;
(b) defining a first patch as including a first plurality of contiguous pixels in the main central image that surrounds or adjoins a first target pixel of the main central image;
(c) defining a plurality of second patches as being located at a set of positions corresponding to the first patch within the one or more remaining main images and the plurality of additional images, wherein a single frame of reference is applied to each of the plurality of main images and each of the plurality of additional images, the single frame of reference including an x-axis and a y-axis, such that a set of x and y coordinates specifying the first target pixel within the main central image also specifies a substantially identical position within each of the remaining main images and each of the plurality of additional images;
(d) determining a set of patch similarity weights by comparing the first patch to each of the plurality of second patches;
(e) applying the set of patch similarity weights to the first target pixel to provide a first filtered pixel value for the first target pixel of the main central image; and
(f) repeating (b), (c), (d), and (e) in relation to one or more additional target pixels of the main central image so as to provide one or more additional filtered pixel values for each of the one or more additional target pixels,
wherein respective ones of the first and additional filtered pixel values are respectively provided for each of the respective first and additional target pixels.

2. The method of claim 1, wherein the one or more additional target pixels includes a plurality of the additional target pixels, and further comprising determining the set of patch similarity weights using a non-local means filtering procedure wherein the defining of the first patch, the defining of the plurality of second patches, the determining of the set of patch similarity weights, and the applying of the set of patch similarity weights are repeated for each of the plurality of the additional target pixels of the main central image.

3. The method of claim 1 wherein the determining of the set of patch similarity weights is performed with reference to at least one characteristic or attribute of the first patch and the plurality of second patches,
wherein the at least one characteristic or attribute comprises one or more of a grey scale value, a luminance value, a chrominance value, a red (R) value, a green (G) value, a blue (B) value, or any of various combinations thereof and,
wherein, when the at least one characteristic or attribute comprises one or both of the luminance value or the chrominance value, the luminance value or chrominance value can be in terms of a Y′UV, L*a*b, Luv or other color space.

4. The method of claim 1 wherein the gathering of the plurality of sequential image sets is performed using a first image sensor array that gathers the main sequential image set, and using a second image sensor array that gathers the one or more additional sequential image sets.

5. The method of claim 4, wherein the first image sensor array includes a clear image sensor configured to generate a greyscale W value having a first absolute intensity level,
wherein the second image sensor array includes a color image sensor with a predetermined pattern of color pixels and is configured to generate one or more color pixel signals based at least indirectly upon which is generated a luma Y′ value having a second absolute intensity level, and
wherein a set of custom weights is obtained by further weighting one or more of the patch similarity weights with accounting relative noise characteristics associated with the clear image sensor and the color image sensor that are derived by estimating read and shot noise characteristics associated with the sensors.

6. The method of claim 5, wherein the method further comprises improving a match between the first and second absolute intensity levels, such that the first absolute intensity level is closer to the second absolute intensity level, so as to achieve an enhanced performance level in regard to a joint clear color denoising operation.

7. The method of claim 6 further comprising calculating a mean offset value between a central patch of a clear image gathered by the first image sensor array and a luma Y′ component of a central patch of a color image gathered by the second image sensor array, wherein the mean offset value is added in real time to all pixels within a window in the color image, thus making the central patch of the color image more similar to the central patch of the clear image and additionally making one or more other patches of the color image within the window more similar to one or more other patches of the clear image, such that one or more desired estimations of the patch similarity weights between the clear and color images is or are achieved.

8. The method of claim 7, further comprising determining an intensity offset between clear and color image pixels for each of the clear and color image pixels, wherein the determining of the intensity offset includes one or more of:
1) estimating the intensity offset by way of a difference of mean pixel intensity values or a mean value of pixel intensity differences over correspondent patches of the clear and color images; or
2) employing an additional patch having a second size that is larger than, or otherwise is of a different size relative to, a first size of the first patch employed during the determining of the patch similarity weights; or
3) identifying an intensity offset value corresponding to a maximum similarity between a color patch histogram and a clear patch histogram.

9. The method of claim 8, wherein a set of RGB to luma conversion coefficients is estimated to achieve or substantially achieve a match of one or more clear pixel values to one or more luma values associated with the color image, so as to allow for enhanced non-local means (NLM) based joint clear-luma denoising.

10. The method of claim 7, wherein a set of RGB to luma conversion coefficients is estimated to achieve or substantially achieve a match of one or more clear pixel values to one or more luma values associated with the color image, so as to allow for enhanced non-local means (NLM) based joint clear-luma denoising.

11. An apparatus comprising:
a camera array including a main camera or image sensor array and one or more additional cameras or image sensor arrays, wherein the main camera or image sensor array is configured for gathering a main sequential image set from a scene, and the one or more additional cameras or image sensor arrays are configured for gathering one or more additional sequential image sets from the scene, the main sequential image set including a plurality of main images comprising a main central image that is at or proximate to a temporal midpoint of the set, and one or more remaining main images, and the one or more additional sequential image sets each including a respective plurality of additional images comprising an additional central image that is at or proximate to a temporal midpoint of the set, and one or more additional remaining images;
a processing mechanism, operatively coupled to the camera array, and configured for each of
(a) defining a first patch as including a first plurality of contiguous pixels in the main central image that surrounds or adjoins a first target pixel of the main central image;
(b) defining a plurality of second patches as being located at a set of positions corresponding to the first patch within the one or more remaining main images and the plurality of additional images, wherein a single frame of reference is applied to each of the plurality of main images and each of the plurality of additional images, the single frame of reference including an x-axis and a y-axis, such that a set of x and y coordinates specifying the first target pixel within the main central image also specifies a substantially identical position within each of the remaining main images and each of the plurality of additional images;
(c) determining a set of patch similarity weights by comparing the first patch to each of the plurality of second patches;
(d) applying the set of patch similarity weights to the first target pixel to provide a first filtered pixel value for the first target pixel of the main central image; and
(e) repeating (a), (b), (c), and (d) in relation to one or more additional target pixels of the main central image so as to provide one or more additional filtered pixel values for each of the one or more additional target pixels.

12. The apparatus of claim 11, wherein the one or more additional target pixels includes a plurality of additional target pixels, and
wherein the processing mechanism is further configured for determining the set of patch similarity weights using a non-local means filtering procedure wherein the defining of the first patch, the defining of the plurality of second patches, the determining of the set of patch similarity weights, and the applying of the set of patch similarity weights are repeated for each of the plurality of the additional target pixels of the main central image.

13. The apparatus of claim 11, wherein the processing mechanism is further configured for determining the set of patch similarity weights with reference to at least one characteristic or attribute of the first patch and the plurality of second patches,
wherein the at least one characteristic or attribute comprises one or more of a grey scale value, a luminance value, a chrominance value, a red (R) value, a green (G) value, a blue (B) value, or any of various combinations thereof, and
wherein, when the at least one characteristic or attribute comprises one or both of the luminance value or the chrominance value, the luminance value or chrominance value can be in terms of a Y′UV, L*a*b, Luv or other color space.

14. The apparatus of claim 11 further comprising a first image sensor array and a second image sensor array, wherein the gathering of the plurality of sequential image sets is performed using the first image sensor array to gather the main sequential image set, and using the second image sensor array to gather the one or more additional sequential image sets.

15. The apparatus of claim 14, wherein the first image sensor array includes a clear image sensor configured to generate a greyscale W value having a first absolute intensity level,
wherein the second image sensor array includes a color image sensor with a predetermined pattern of color pixels and is configured to generate one or more color pixel signals based at least indirectly upon which is generated a luma Y′ value having a second absolute intensity level, and
wherein a set of custom weights is obtained by further weighting one or more of the patch similarity weights with accounting relative noise characteristics associated with the clear sensor and the color image sensor of the camera array that are derived by estimating read and shot noise characteristics associated with the sensors.

16. The apparatus of claim 15, wherein the processing mechanism is further configured to operate to improve a match between the first and second absolute intensity levels, such that the first absolute intensity level is closer to the second absolute intensity level, so as to achieve an enhanced performance level in regard to a joint clear color denoising operation.

17. The apparatus of claim 16 wherein the processing mechanism is further configured for calculating a mean offset value between a central patch of a clear image gathered by the first image sensor array and a luma Y′ component of a central patch of a color image gathered by the second image sensor array, wherein the mean offset value is added in real time to all pixels within a window in the color image, thus making the central patch of the color image more similar to the central patch of the clear image and additionally making one or more other patches of the color image within the window more similar to one or more other patches of the clear image, such that one or more desired estimations of the patch similarity weights between the clear and color images is or are achieved.

18. The apparatus of claim 17, wherein the processing mechanism is further configured for determining an intensity offset between clear and color image pixels for each of the clear and color image pixels, wherein the determining of the intensity offset includes one or more of:
1) estimating the intensity offset by way of a difference of mean pixel intensity values or a mean value of pixel intensity differences over correspondent patches of the clear and color images; or
2) employing an additional patch having a second size that is larger than, or otherwise is of a different size relative to, a first size of the first patch employed during the determining of the patch similarity weights; or
3) identifying an intensity offset value corresponding to a maximum similarity between a color patch histogram and a clear patch histogram.

19. The apparatus of claim 18, wherein the processing mechanism additionally is configured to operate so that a set of RGB to luma conversion coefficients is estimated to achieve or substantially achieve a match of one or more clear pixel values to one or more luma values associated with the color image, so as to allow for enhanced non-local means (NLM) based joint clear-luma denoising.

20. The apparatus of claim 17, wherein the processing mechanism additionally is configured to operate so that a set of RGB to luma conversion coefficients is estimated to achieve or substantially achieve a match of one or more clear pixel values to one or more luma values associated with the color image, so as to allow for enhanced non-local means (NLM) based joint clear-luma denoising.

21. A non-transitory computer readable memory encoded with a computer program comprising computer readable instructions recorded thereon for execution of a method that includes:
(a) gathering a plurality of sequential image sets from a scene, the plurality of sequential image sets including at least a main sequential image set and one or more additional sequential image sets, wherein the main sequential image set includes a plurality of main images comprising a main central image that is at or proximate to a temporal midpoint of the set, and one or more remaining main images, and wherein the one or more additional sequential image sets each include a respective plurality of additional images comprising an additional central image that is at or proximate to a temporal midpoint of the set, and one or more additional remaining images;
(b) defining a first patch as including a first plurality of contiguous pixels in the main central image that surrounds or adjoins a first target pixel of the main central image;
(c) defining a plurality of second patches as being located at a set of positions corresponding to the first patch within the one or more remaining main images and the plurality of additional images, wherein a single frame of reference is applied to each of the plurality of main images and each of the plurality of additional images, the single frame of reference including an x-axis and a y-axis, such that a set of x and y coordinates specifying the first target pixel within the main central image also specifies a substantially identical position within each of the remaining main images and each of the plurality of additional images;
(d) determining a set of patch similarity weights by comparing the first patch to each of the plurality of second patches; and
(e) applying the set of patch similarity weights to the first target pixel to provide a first filtered pixel value for the first target pixel of the main central image; and
(f) repeating (b), (c), (d), and (e) in relation to one or more additional target pixels of the main central image so as to provide one or more additional filtered pixel values for each of the one or more additional target pixels.

22. The non-transitory computer readable memory of claim 21, wherein the one or more additional target pixels includes a plurality of the additional target pixels, and further including instructions for determining the set of patch similarity weights using a non-local means filtering procedure, wherein the repeating of (b), (c), (d), and (e) is in relation to each of the plurality of additional target pixels of the main central image.

23. The non-transitory computer readable memory of claim 21 further including instructions for determining the set of patch similarity weights with reference to at least one characteristic or attribute of the first patch and the plurality of second patches,
wherein the at least one characteristic or attribute comprises one or more of a grey scale value, a luminance value, a chrominance value, a red (R) value, a green (G) value, a blue (B) value, or any of various combinations thereof and,
wherein, when the at least one characteristic or attribute comprises one or both of the luminance value or the chrominance value, the luminance value or chrominance value can be in terms of a Y′UV, L*a*b, Luv or other color space.
